(19) United States
(12) Patent Application Publication
(10) Pub. No.: US 2025/0037402 A1
(43) Pub. Date: Jan. 30, 2025

(54) POSITION POSTURE ESTIMATION METHOD, POSITION POSTURE ESTIMATION DEVICE, AND PROGRAM

(71) Applicant: NIPPON TELEGRAPH AND TELEPHONE CORPORATION, Tokyo (JP)

(72) Inventors: Yasuhiro YAO, Tokyo (JP); Kana KURATA, Tokyo (JP); Shingo ANDO, Tokyo (JP); Jun SHIMAMURA, Tokyo (JP)

(73) Assignee: NIPPON TELEGRAPH AND TELEPHONE CORPORATION, Tokyo (JP)

(21) Appl. No.: 18/716,509

(22) PCT Filed: Dec. 6, 2021
(86) PCT No.: PCT/JP2021/044783

§ 371 Date: Jun. 5, 2024

(51) Int. Cl. G06T 19/20

(52) U.S. Cl. CPC G06T 19/20; G06T 2219/2016

(57) ABSTRACT

A position and posture estimation device acquires three-dimensional point cloud data at each of times and position data at each of times, the three-dimensional point cloud data being measured every time a first time elapses, the position data being measured every time a second time longer than the first time elapses. The position and posture estimation device estimates a local position in a local coordinate system and a local posture in the local coordinate system. The position and posture estimation device estimates an estimated absolute position and an estimated absolute posture in an absolute coordinate system every time the position data is acquired. The position and posture estimation device generates provisional three-dimensional point cloud data in the absolute coordinate system every time the position data is acquired. The position and posture estimation device generates composite data obtained by integrating the provisional three-dimensional point cloud data and map point cloud data generated from three-dimensional point cloud data previously measured, and corrects the estimated absolute position and the estimated absolute posture to increase a degree of coincidence between the composite data and the map point cloud data.

### TECHNICAL FIELD

The disclosed technology relates to a position and posture estimation method, a position and posture estimation device, and a program.

### BACKGROUND ART

A technology for estimating a position of a mobile body using light detection and ranging (LiDAR) is conventionally known (for example, Non Patent Literature 1 and Non Patent Literature 2). Technologies disclosed in Non Patent Literature 1 and Non Patent Literature 2 estimate a position and a posture of a mobile body in a local coordinate system on the basis of data obtained by LiDAR.

In addition, there is known a technology for estimating an absolute position and an absolute posture of a mobile body when the mobile body moves on which a global positioning system (GPS), a LiDAR, and an inertial measurement unit (IMU) are mounted (for example, Non Patent Literature 3).

### CITATION LIST

### Non Patent Literature

Non Patent Literature 1: Zhang, J., & Singh, S. (2014 July). LOAM: Lidar Odometry and Mapping in Real-time. In Robotics: Science and Systems (Vol. 2, No. 9). Non Patent Literature 2: Shan, T., & Englot, B. (2018 October). Lego-loam: Lightweight and ground-optimized lidar odometry and mapping on variable terrain. In 2018 IEEE/RSJ International Conference on Intelligent Robots and Systems (IROS) (pp. 4758-4765). IEEE.

Non Patent Literature 3: Shan, T., Englot, B., Meyers, D., Wang, W., Ratti, C., & Rus, D. (2020 October). Lio-sam: Tightly-coupled lidar inertial odometry via smoothing and mapping. In 2020 IEEE/RSJ International Conference on Intelligent Robots and Systems (IROS) (pp. 5135-5142). IEEE.

### SUMMARY OF INVENTION

### Technical Problem

The technologies disclosed in Non Patent Literature 1 and Non Patent Literature 2 are technologies for estimating a position and a posture of a mobile body in the local coordinate system on the basis of only data obtained by LiDAR. For this reason, the technology disclosed in Non Patent Literature 1 cannot estimate a position and a posture of the mobile body in an absolute coordinate system with a predetermined position on Earth as the origin.

On the other hand, when a technology disclosed in Non Patent Literature 3 is used, it is necessary that accurate calibration is performed between the LiDAR and the IMU. Specifically, it is necessary that a difference between installation angles of the two sensors of the LiDAR and the IMU is known. For this reason, even if the technology disclosed in Non Patent Literature 3 is used in a state where calibration is not performed between the LiDAR and the IMU, estimation accuracy of the position and the posture of the mobile body in the absolute coordinate system is low.

The disclosed technology has been made in view of the above points, and an object thereof is to accurately estimate a position and a posture of a mobile body in the absolute coordinate system on the basis of position data obtained by a position measuring device mounted on the mobile body and three-dimensional point cloud data obtained by a measuring instrument mounted on the mobile body.

### Solution to Problem

A first aspect of the present disclosure is a position and posture estimation method in which a computer executes processing including: acquiring three-dimensional point cloud data at each of times and position data at each of times, the three-dimensional point cloud data being measured every time a first time elapses by a measuring instrument mounted on a mobile body, the position data being measured every time a second time longer than the first time elapses by a position measuring device mounted on the mobile body; estimating a local position representing a position of the mobile body in a local coordinate system with a position at a start of movement of the mobile body as the origin and a local posture representing a posture of the mobile body in the local coordinate system, on the basis of the three-dimensional point cloud data acquired, every time the three-dimensional point cloud data is acquired with a lapse of the first time; estimating an estimated absolute position that is a position of the mobile body in an absolute coordinate system with a predetermined position on Earth as the origin on the basis of the local position of the mobile body, and estimating an estimated absolute posture that is a posture of the mobile body in the absolute coordinate system on the basis of the local posture of the mobile body, every time the position data is acquired with a lapse of the second time; and generating provisional three-dimensional point cloud data at each of times in the absolute coordinate system for each of pieces of the three-dimensional point cloud data at each of times, the three-dimensional point cloud data being measured every time the first time elapses, generating composite data obtained by integrating the provisional three-dimensional point cloud data and map point cloud data generated from three-dimensional point cloud data previously measured, for each of pieces of the provisional three-dimensional point cloud data at each of times, and generating a corrected absolute position obtained by correcting the estimated absolute position and a corrected absolute posture obtained by correcting the estimated absolute posture, by correcting the estimated absolute position and the estimated absolute posture to increase a degree of coincidence between the composite data and the map point cloud data, every time the position data is acquired with the lapse of the second time.

A second aspect of the present disclosure is a position and posture estimation device including: an acquisition unit that acquires three-dimensional point cloud data at each of times and position data at each of times, the three-dimensional point cloud data being measured every time a first time elapses by a measuring instrument mounted on a mobile body, the position data being measured every time a second time longer than the first time elapses by a position measuring device mounted on the mobile body; a first estimation unit that estimates a local position representing a position of the mobile body in a local coordinate system with a position at a start of movement of the mobile body as the origin and a local posture representing a posture of the mobile body in the local coordinate system, on the basis of the three-dimensional point cloud data acquired, every time the three-dimensional point cloud data is acquired with a lapse of the first time; a second estimation unit that estimates an estimated absolute position that is a position of the mobile body in an absolute coordinate system with a predetermined position on Earth as the origin on the basis of the local position of the mobile body, and estimates an estimated absolute posture that is a posture of the mobile body in the absolute coordinate system on the basis of the local posture of the mobile body, every time the position data is acquired with a lapse of the second time; and a correction unit that generates provisional three-dimensional point cloud data at each of times in the absolute coordinate system for each of pieces of the three-dimensional point cloud data at each of times, the three-dimensional point cloud data being measured every time the first time elapses, generates composite data obtained by integrating the provisional three-dimensional point cloud data and map point cloud data generated from three-dimensional point cloud data previously measured, for each of pieces of the provisional three-dimensional point cloud data at each of times, and generates a corrected absolute position obtained by correcting the estimated absolute position and a corrected absolute posture obtained by correcting the estimated absolute posture, by correcting the estimated absolute position and the estimated absolute posture to increase a degree of coincidence between the composite data and the map point cloud data, every time the position data is acquired with the lapse of the second time.

A third aspect of the present disclosure is a program for causing a computer to execute processing including: acquiring three-dimensional point cloud data at each of times and position data at each of times, the three-dimensional point cloud data being measured every time a first time elapses by a measuring instrument mounted on a mobile body, the position data being measured every time a second time longer than the first time elapses by a position measuring device mounted on the mobile body; estimating a local position representing a position of the mobile body in a local coordinate system with a position at a start of movement of the mobile body as the origin and a local posture representing a posture of the mobile body in the local coordinate system, on the basis of the three-dimensional point cloud data acquired, every time the three-dimensional point cloud data is acquired with a lapse of the first time; estimating an estimated absolute position that is a position of the mobile body in an absolute coordinate system with a predetermined position on Earth as the origin on the basis of the local position of the mobile body, and estimating an estimated absolute posture that is a posture of the mobile body in the absolute coordinate system on the basis of the local posture of the mobile body, every time the position data is acquired with a lapse of the second time; and generating provisional three-dimensional point cloud data at each of times in the absolute coordinate system for each of pieces of the three-dimensional point cloud data at each of times, the three-dimensional point cloud data being measured every time the first time elapses, generating composite data obtained by integrating the provisional three-dimensional point cloud data and map point cloud data generated from three-dimensional point cloud data previously measured, for each of pieces of the provisional three-dimensional point cloud data at each of times, and generating a corrected absolute position obtained by correcting the estimated absolute position and a corrected absolute posture obtained by correcting the estimated absolute posture, by correcting the estimated absolute position and the estimated absolute posture to increase a degree of coincidence between the composite data and the map point cloud data, every time the position data is acquired with the lapse of the second time.

### Advantageous Effects of Invention

According to the disclosed technology, it is possible to accurately estimate the position and the posture of the mobile body in the absolute coordinate system on the basis of the position data obtained by the position measuring device mounted on the mobile body and the three-dimensional point cloud data obtained by the measuring instrument mounted on the mobile body.

### BRIEF DESCRIPTION OF DRAWINGS

FIG. 1 is a block diagram illustrating a hardware configuration of a position and posture estimation device 10 according to a present embodiment.

FIG. 2 is a block diagram illustrating an example of functional components of the position and posture estimation device 10 according to the present embodiment.

FIG. 3 is a diagram for explaining coordinate systems.

FIG. 4 is a diagram for explaining the coordinate systems.

FIG. 5 is a diagram for explaining an outline of processing executed by a second estimation unit 126 and a correction unit 128.

FIG. 6 is a flowchart illustrating a flow of processing by the position and posture estimation device 10 according to the present embodiment.

FIG. 7 is a flowchart illustrating a flow of processing by the position and posture estimation device 10 according to the present embodiment.

### DESCRIPTION OF EMBODIMENTS

Hereinafter, an example of an embodiment of the disclosed technology will be described with reference to the drawings. Note that same or equivalent components and portions are denoted by the same reference numerals in the drawings. In addition, dimensional ratios in the drawings are exaggerated for convenience of description and thus may be different from actual ratios.

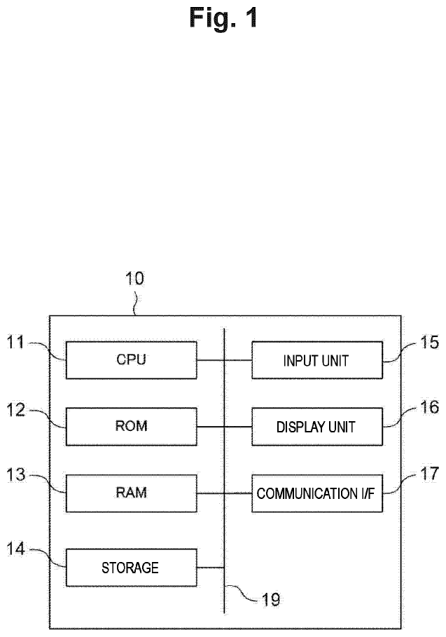

FIG. 1 is a block diagram illustrating a hardware configuration of a position and posture estimation device 10. As illustrated in FIG. 1, the position and posture estimation device 10 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 19.

The CPU 11 is a central processing unit, and executes various programs and controls each unit. That is, the CPU 11 reads a program from the ROM 12 or the storage 14, and executes the program using the RAM 13 as a working area. The CPU 11 performs control of each of the components described above and various types of calculation processing in accordance with a program stored in the ROM 12 or the storage 14. In the present embodiment, the ROM 12 or the storage 14 stores a program for estimating a position and a posture of a mobile body.

The ROM 12 stores various programs and various data. The RAM 13 serving as a working area temporarily stores programs or data. The storage 14 includes a storage device such as a hard disk drive (HDD) or a solid state drive (SSD), and stores various programs including an operating system and various data.

The input unit 15 includes a pointing device such as a mouse and a keyboard, and is used to perform various inputs.

The display unit 16 is, for example, a liquid crystal display and displays various types of information. The display unit 16 may function as the input unit 15 by adopting a touch panel system.

The communication interface 17 is an interface for communicating with another device such as a portable terminal. For the communication, for example, a wired communication standard such as Ethernet (registered trademark) or FDDI, or a wireless communication standard such as 4G, 5G, or Wi-Fi (registered trademark) is used.

Next, functional components of the position and posture estimation device 10 will be described.

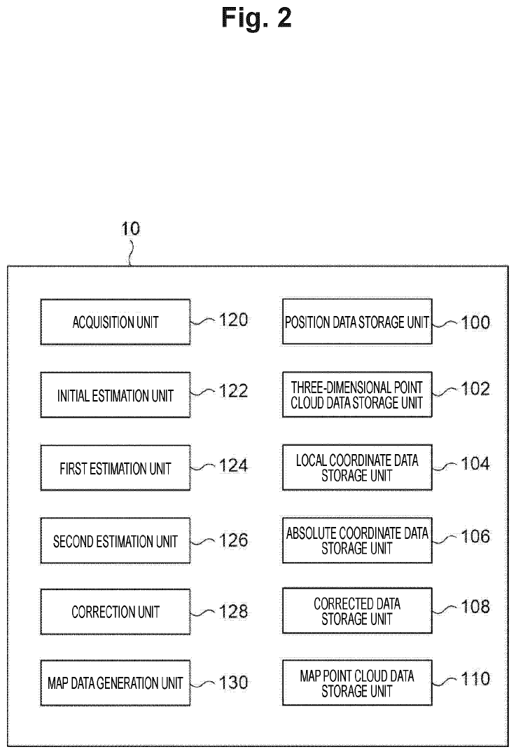

FIG. 2 is a block diagram illustrating an example of the functional components of the position and posture estimation device 10.

As illustrated in FIG. 2, the position and posture estimation device 10 includes, as the functional components, a position data storage unit 100, a three-dimensional point cloud data storage unit 102, a local coordinate data storage unit 104, an absolute coordinate data storage unit 106, a corrected data storage unit 108, a map point cloud data storage unit 110, an acquisition unit 120, an initial estimation unit 122, a first estimation unit 124, a second estimation unit 126, a correction unit 128, and a map data generation unit 130. Each functional component is implemented by the CPU 11 reading a program stored in the ROM 12 or the storage 14, loading the program to the RAM 13, and executing the program.

In addition, terms appearing in the present embodiment will be described below.

An absolute coordinate system is a coordinate system with a predetermined position on Earth as the origin. A position and a posture of a mobile body are projected with respect to the absolute coordinate system, whereby the position and the posture of the mobile body on Earth are specified. For example, the posture of the mobile body is represented by Euler angles in the case of a planar coordinate system of the world geodetic system. Note that the Euler angles are a roll angle, a pitch angle, and a yaw angle of the mobile body in coordinate systems. Note that the absolute coordinate system may be any coordinate system, for example, a planar rectangular coordinate system.

A device coordinate system is a coordinate system in which a position of a measuring instrument mounted on the mobile body is set as the origin. In the present embodiment, the measuring instrument mounted on the mobile body is a LiDAR. For this reason, in the present embodiment, the coordinate system with a position of the LiDAR at each time as the origin is the device coordinate system.

A local coordinate system is a coordinate system in which a position at the start of movement of the mobile body is set as the origin, and a roll angle, a pitch angle, and a yaw angle representing a posture at the start of movement of the mobile body are set as an initial posture (for example, 0 degrees).

A GPS is an example of a position measuring device mounted on the mobile body, and measures latitude, longitude, and altitude of the mobile body.

The LiDAR is an example of the measuring instrument mounted on the mobile body. The LiDAR is a device that acquires surrounding three-dimensional point cloud data from a time until a laser beam hits an object and bounces back when the laser beam is emitted to the outside.

An IMU is a sensor unit equipped with an accelerometer, an angular accelerometer, and a compass.

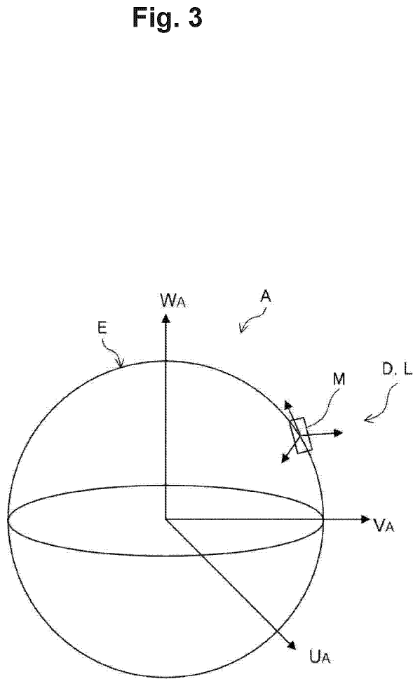

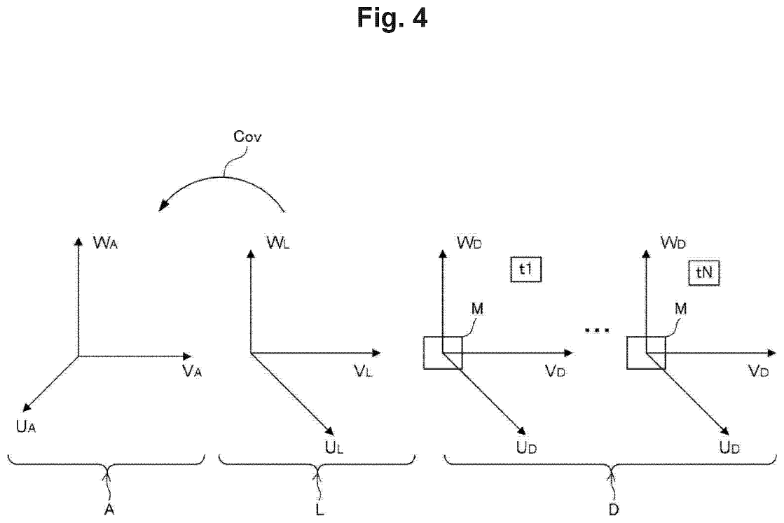

FIGS. 3 and 4 are diagrams for explaining an absolute coordinate system, a device coordinate system, and a local coordinate system. FIG. 3 schematically illustrates an absolute coordinate system A, a device coordinate system D, a local coordinate system L, Earth E, and a mobile body M. In the example of FIG. 3, the origin of the absolute coordinate system A is the center of gravity of Earth E. For example, a case is considered where the mobile body M is an airplane. In this case, for example, in the absolute coordinate system A, the Euler angles are set to 0 degrees in a case where the mobile body is horizontal facing north. On the other hand, for example, in the local coordinate system L, the Euler angles are set to 0 degrees in a case where the mobile body is horizontal facing east. On the other hand, in the device coordinate system D, a position of the mobile body at each time is set as the origin, and a posture of the mobile body at each time is set as an initial posture (for example, 0 degrees). Note that, the absolute coordinate system A of FIG. 3 has UA, VA, and WA as its coordinate axes.

In addition, as illustrated in FIG. 4, while the absolute coordinate system A and the local coordinate system L are fixed, the device coordinate system D moves in accordance with movement of the mobile body M. The device coordinate system D at a time t1 in FIG. 4 is different from the device coordinate system D at a time tN. For this reason, in the case of calculating a position and a posture of the mobile body M at each time in the absolute coordinate system A, it is necessary to perform coordinate conversion to project a position and a posture of the mobile body M in the local coordinate system L and the device coordinate system D onto the absolute coordinate system A. Note that, in the present embodiment, coordinate conversion Cov from the local coordinate system L to the absolute coordinate system A is executed. The local coordinate system L of FIG. 4 has U_{L}, V_{L}, and W_{L} as its coordinate axes, and the device coordinate system D has U_{D}, V_{D}, and W_{D} as its coordinate axes.

A time interval at which position data of the mobile body is measured by the GPS is longer than a time interval at which three-dimensional point cloud data around the mobile body is measured by the LiDAR. For example, the time interval at which the position data of the mobile body is measured by the GPS is 1 second, and the time interval at which the three-dimensional point cloud data around the mobile body is measured by the LiDAR is 0.1 seconds. Hereinafter, the time interval at which the three-dimensional point cloud data around the mobile body is measured by the LiDAR is referred to as a first time, and the time interval at which the position data of the mobile body is measured by the GPS is referred to as a second time.

In the three-dimensional point cloud data measured by the LiDAR, accumulation of error called drift occurs. For this reason, when the position and the posture of the mobile body in the absolute coordinate system are calculated by using the three-dimensional point cloud data at each time, this drift causes a bad influence, and the position and the posture of the mobile body in the absolute coordinate system cannot be accurately estimated.

Thus, in the present embodiment, every time position data of the mobile body is acquired by the GPS, the influence of the drift is reduced by estimating the position and the posture of the mobile body in the absolute coordinate system on the basis of the position data, and the position and the posture of the mobile body in the absolute coordinate system are accurately estimated. In addition, in the present embodiment, map point cloud data depending on movement of the mobile body is generated on the basis of the position and the posture of the mobile body in the absolute coordinate system estimated. The map point cloud data is useful, for example, when a position of an object on Earth is obtained.

Hereinafter, a specific description will be given. Note that, in the following description, it is assumed that an attachment position of the LiDAR in the mobile body and an attachment position of the GPS in the mobile body are close to each other, and a difference between the positions of both devices is negligible. Such an aspect can be implemented, for example, by attaching the GPS to an upper surface of the LiDAR mounted on the mobile body. In addition, in the present embodiment, the position of the mobile body is represented by three-dimensional parameters, and the posture of the mobile body is represented by three-dimensional parameters of a roll angle, a pitch angle, and a yaw angle.

The position data storage unit 100 stores position data at each time measured by the GPS mounted on the mobile body. Note that, as described above, the position data of the mobile body is measured by the GPS every time the second time elapses. Note that, in the present embodiment, the position data stored in the position data storage unit 100 is not latitude, longitude, and altitude itself, but data converted into an absolute coordinate system such as the world geodetic coordinate system.

The three-dimensional point cloud data storage unit 102 stores three-dimensional point cloud data at each time measured by the LiDAR mounted on the mobile body. Note that, as described above, the three-dimensional point cloud data around the mobile body is measured by the LiDAR every time the first time elapses.

In addition, in the following description, the time is expressed as X_Y.

X is a variable to which 1 is added every time the position data is measured by the GPS with a time when the position data is first measured by the GPS as 0.

Y is a variable to which 1 is added every time the three-dimensional point cloud data is obtained by the LiDAR with a time when the three-dimensional point cloud data is obtained by the LiDAR for the first time after the latest position data is obtained as 0.

For example, in a case where measurement of the position data by the GPS is performed at 1 Hz and measurement of the three-dimensional point cloud data by the LiDAR is performed at 10 Hz, the times X and Y increase as follows.
0_0, 0_1, 0_2, . . . , 0_9, 1_0, 1_1, 1_2, . . . , 1_9, 2_0, 2 1, . . .

Hereinafter, it is assumed that measurement of the three-dimensional point cloud data by the LiDAR is performed N+1 times within a time interval at which the position data is measured by the GPS. That is, the times X and Y increase as follows.

0_0, 0_1, 0_2, . . . , 0_N−1, 0_N, 1_0, 1_1, . . .

The local coordinate data storage unit 104 stores a local position representing a position of the mobile body at each time in the local coordinate system and a local posture representing a posture of the mobile body at each time in the local coordinate system. Note that the local position and the local posture are estimated by the first estimation unit 124 described later.

The absolute coordinate data storage unit 106 stores an estimated absolute position that is a position of the mobile body at each time in the absolute coordinate system and an estimated absolute posture that is a posture of the mobile body at each time in the absolute coordinate system. Note that the estimated absolute position and the estimated absolute posture are estimated by the second estimation unit 126 described later.

The corrected data storage unit 108 stores a corrected absolute position that is data obtained by correcting the estimated absolute position and a corrected absolute posture that is data obtained by correcting the estimated absolute posture. Note that the corrected absolute position and the corrected absolute posture are generated by the correction unit 128 described later.

The map point cloud data storage unit 110 stores map point cloud data generated from the three-dimensional point cloud data at each time. The map point cloud data is generated by integrating the three-dimensional point cloud data at each time collected in accordance with movement of the mobile body.

When new position data (Hereinafter, it is referred to as position data of the current time.) is stored in the position data storage unit 100, the acquisition unit 120 acquires three-dimensional point cloud data measured at each time from storage of the position data of the previous time to storage of the position data of the current time, position data of the current time, and position data of the previous time.

The initial estimation unit 122 estimates translation from a local position of the mobile body in the local coordinate system to an estimated absolute position of the mobile body in the absolute coordinate system, and estimates rotation from a local posture of the mobile body in the local coordinate system to an estimated absolute posture of the mobile body in the absolute coordinate system.

Specifically, the initial estimation unit 122 estimates the rotation and the translation for executing geometric conversion from the local coordinate system to the absolute coordinate system, and estimates a position and a posture of the mobile body in the absolute coordinate system at a time 0_0.

More specifically, first, the initial estimation unit 122 estimates a translation element of the geometric conversion from the local coordinate system to the absolute coordinate system by setting a position represented by position data measured by the GPS at the time 0_0 as the position of the mobile body in the absolute coordinate system at the time 0_0.

Next, the initial estimation unit 122 estimates a position and a posture of the mobile body in the local coordinate system only from the three-dimensional point cloud data measured by the LiDAR by using a known method such as Non Patent Literature 1 or Non Patent Literature 2. Specifically, the initial estimation unit 122 calculates an average of posture of the mobile body from the time 0_0 to a time 1_0 on the basis of a posture of the mobile body at each time in the local coordinate system obtained from a time 0_1 to the time 1_0. Then, the initial estimation unit 122 sets the average of posture of the mobile body from the time 0_0 to the time 1_0 as an initial posture of the mobile body in the local coordinate system.

Next, the initial estimation unit 122 sets, as an initial posture in the absolute coordinate system, a posture obtained by assuming that the mobile body moves in a constant posture from the time 0_0 to the time 1_0, which is obtained by a difference between position data measured by the GPS at the time 0_0 and position data measured by the GPS at the time 1_0. Specifically, a vector representing movement from a position represented by position data at the time 0_0 toward a position represented by a position data at the time 1_0 is set as the initial posture of the mobile body in the absolute coordinate system.

Then, the initial estimation unit 122 estimates a rotation element of the geometric conversion from the local coordinate system to the absolute coordinate system by assuming that the initial posture of the mobile body in the local coordinate system is equal to the initial posture of the mobile body in the absolute coordinate system. As a result, it is specified what angle of posture in the absolute coordinate system is the posture of 0 degrees in the local coordinate system. Note that, the translation element and the rotation element representing the coordinate conversion, which are estimated by the initial estimation unit 112, are used at the time of coordinate conversion in the first estimation unit 124, the second estimation unit 126, and the correction unit 128 described later.

Every time three-dimensional point cloud data is acquired with a lapse of the first time and the three-dimensional point cloud data is stored in the three-dimensional point cloud data storage unit 102, the first estimation unit 124 estimates a local position representing a position of the mobile body in the local coordinate system and a local posture representing a posture of the mobile body in the local coordinate system on the basis of the three-dimensional point cloud data acquired by the acquisition unit 120 by using the known method such as Non Patent Literature 1 or Non Patent Literature 2.

Every time position data is acquired with a lapse of the second time and the position data is stored in the position data storage unit 100, the second estimation unit 126 estimates the estimated absolute position that is a position of the mobile body in the absolute coordinate system on the basis of the local position of the mobile body estimated by the first estimation unit 124. In addition, every time the position data is acquired with the lapse of the second time and the position data is stored in the position data storage unit 100, the second estimation unit 126 estimates the estimated absolute posture that is a posture of the mobile body in the absolute coordinate system on the basis of a local posture of the mobile body estimated by the first estimation unit 124.

As described above, the second estimation unit 126 estimates the estimated absolute position and the estimated absolute posture every time a time X_0 arrives at which the position data is acquired with the lapse of the second time. By processing executed by the second estimation unit 126, the position data measured by the GPS and the three-dimensional point cloud data measured by the LiDAR are integrated, and the estimated absolute position and the estimated absolute posture are estimated. As a result, the drift occurring in the LiDAR is reduced, and the estimated absolute position and the estimated absolute posture in the absolute coordinate system are accurately estimated.

Specifically, every time the position data is acquired with the lapse of the second time, the second estimation unit 126 sets the local position of the mobile body estimated by the first estimation unit 124 as the estimated absolute position. For this reason, the estimated absolute position at the time X_0 corresponds to the position data by the GPS obtained at the time X_0.

In addition, every time the position data is acquired with the lapse of the second time, the second estimation unit 126 applies rotation representing a difference between a local posture of the mobile body estimated by the first estimation unit 124 at the current time and a local posture of the mobile body estimated at the previous time by the first estimation unit 124 to the corrected absolute posture of the mobile body obtained at the time of position data acquisition of the previous time, thereby estimating an estimated absolute posture that is a posture in the absolute coordinate system of the current time. Specifically, the second estimation unit 126 estimates the estimated absolute posture at the time X_0, by applying rotation corresponding to a difference between the local posture at a time X−1_0 and the local posture at the time X_0 estimated by the first estimation unit 124 to the corrected absolute posture at the time X−1_0. Note that the corrected absolute posture and the corrected absolute position are generated by the correction unit 128 described later.

In addition, the second estimation unit 126 estimates the estimated absolute position at each time and the estimated absolute posture at each time on the basis of a local position of the mobile body at each time and a local posture of the mobile body at each time estimated by the first estimation unit 124 every time the first time elapses. Specifically, the second estimation unit 126 estimates the estimated absolute position and the estimated absolute posture at each time between the time X−1_0 when the position data is acquired at the previous time and the time X_0 when the position data is acquired at the current time. For example, the second estimation unit 126 estimates the estimated absolute position and the estimated absolute posture at a time X−1_N, by applying rotation and translation representing a difference from the time X−1_N to time X−1_0 of the local position and the local posture estimated by the first estimation unit 124, to the corrected absolute position and the corrected absolute posture at the time X−1_0.

Every time the position data is acquired with the lapse of the second time, the correction unit 128 generates provisional three-dimensional point cloud data in the absolute coordinate system, by applying the translation and the rotation estimated by the initial estimation unit 122 to the three-dimensional point cloud data at each time measured every time the first time elapses. Then, for each piece of provisional three-dimensional point cloud data at each time, the correction unit 128 generates composite data obtained by integrating the provisional three-dimensional point cloud data at the time and the map point cloud data generated from the three-dimensional point cloud data previously measured. Then, the correction unit 128 generates the corrected absolute position obtained by correcting the estimated absolute position and the corrected absolute posture obtained by correcting the estimated absolute posture, by correcting the estimated absolute position and the corrected absolute posture to increase a degree of coincidence between the composite data generated for each piece of the provisional three-dimensional point cloud data at each time and the map point cloud data.

Specifically, every time the position data is acquired with the lapse of the second time, the correction unit 128 generates the composite data that is three-dimensional point cloud data obtained by combining the provisional three-dimensional point cloud data at each time with the map point cloud data generated up to the previous time. Then, the correction unit 128 calculates a degree of coincidence between the composite data and the map point cloud data by using an iterative closest point (ICP) algorithm for each piece of three-dimensional point cloud data at each time measured every time the first time elapses, and corrects the estimated absolute position and the estimated absolute posture to increase the degree of coincidence between the composite data and the map point cloud data, thereby generating the corrected absolute position and the corrected absolute posture.

For example, the correction unit 128 generates the corrected absolute position and the corrected absolute posture by correcting the estimated absolute position and the estimated absolute posture by using the estimated absolute positions and the estimated absolute postures at times X−1_1, . . . , X−1_N, and X_0, the three-dimensional point cloud data at each time, and the map point cloud data.

Specifically, first, the correction unit 128 applies the translation from the local position to the estimated absolute position and the rotation from the local posture to the estimated absolute posture at each time to the three-dimensional point cloud data at times X−1_1, . . . , X−1_N, . . . , and X_0 to generate provisional three-dimensional point cloud data at each time. Then, for each piece of the provisional three-dimensional point cloud data at each time, the correction unit 128 integrates the provisional three-dimensional point cloud data at the time and the map point cloud data stored in the map point cloud data storage unit 110 to generate each piece of the composite data.

Next, with the estimated absolute position and the estimated absolute posture at each time as initial values, the correction unit 128 generates the corrected absolute position of the mobile body and the corrected absolute posture of the mobile body when the three-dimensional point cloud data is measured by using the iterative closest point (ICP) algorithm to increase overlap between the composite data and the map point cloud data for the three-dimensional point cloud data at each time. This is performed for the three-dimensional point cloud data at all times. Further, this is repeated a plurality of times.

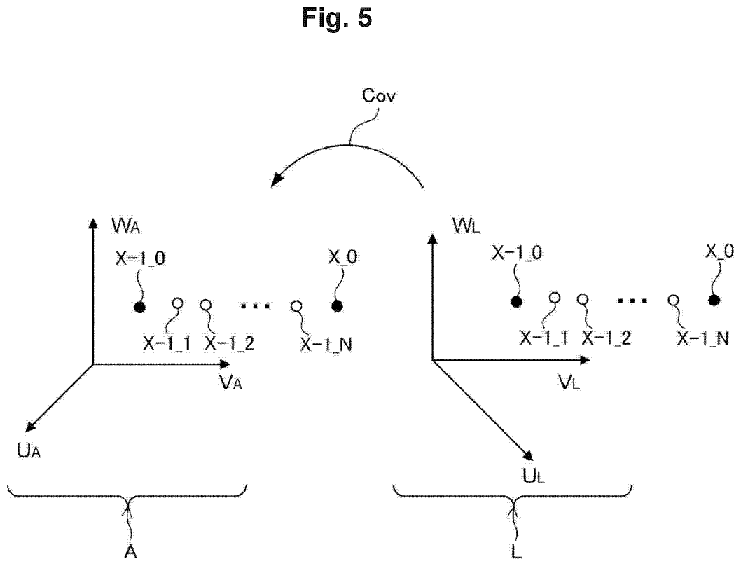

FIG. 5 is a diagram for explaining an outline of processing executed by the second estimation unit 126 and the correction unit 128.

A case is considered where the position data is measured at the time X_0 when the second time elapses after the position data is measured at the time X−1_0 as illustrated in FIG. 5. In this case, the second estimation unit 126 estimates the estimated absolute position of the mobile body and the estimated absolute posture of the mobile body in the absolute coordinate system A at the time X_0 from the local position and the local posture in the local coordinate system L when the position data is measured at the time X_0.

Next, the second estimation unit 126 estimates the estimated absolute position and the estimated absolute posture in the absolute coordinate system A at each of times X−1_1, . . . , and X−1_N at which the three-dimensional point cloud data is measured from the time X−1_0 to the time X_0. At that time, the second estimation unit 126 estimates the estimated absolute position and the estimated absolute posture in the absolute coordinate system A at each of times X−1_1, . . . , and X−1_N at which the three-dimensional point cloud data is measured, on the basis of the rotation and the translation representing changes in the local position and the local posture in the local coordinate system L at each of times X−1_1, . . . , and X−1_N at which the three-dimensional point cloud data is measured. For example, the second estimation unit 126 estimates the estimated absolute position and the estimated absolute posture in the absolute coordinate system A at the time X−1_1, by applying rotation and translation representing a difference between the local position and the local posture at the time X−1_0 and the local position and the local posture at the time X−1_1 in the local coordinate system L, to the corrected absolute position and the corrected absolute posture in the absolute coordinate system A at the time X−1_0. In addition, for example, the second estimation unit 126 estimates the estimated absolute position and the estimated absolute posture in the absolute coordinate system A at a time X−1_2, by applying rotation and translation representing a difference between the local position and the local posture at the time X−1_1 and the local position and the local posture at the time X−1_2 in the local coordinate system L, to the estimated absolute position and the estimated absolute posture in the absolute coordinate system A at the time X−1_1.

Next, the correction unit 128 generates the composite data obtained by combining each piece of the provisional three-dimensional point cloud data in the absolute coordinate system measured at each time up to the time X_0 with the map point cloud data generated from the three-dimensional point cloud data measured at each time up to the time X−1_0. Then, the correction unit 128 generates the corrected absolute position and the corrected absolute posture, by correcting the estimated absolute position and the estimated absolute posture in the absolute coordinate system A at each of the times X−1_1, . . . , and X−1_N at which the three-dimensional point cloud data is measured to increase the degree of coincidence between the composite data and the map point cloud data. Note that, at this time, for each piece of three-dimensional point cloud data at each time, the correction unit 128 generates the corrected absolute position and the corrected absolute posture by correcting the estimated absolute position and the estimated absolute posture at the time when the three-dimensional point cloud data is acquired.

The map data generation unit 130 generates a series of three-dimensional point cloud data in a second time section of the current time by applying the translation and the rotation estimated by the initial estimation unit 122 to each piece of three-dimensional point cloud data at each time measured every time the first time elapses. Next, the map data generation unit 130 generates each piece of three-dimensional point cloud data at each time in the absolute coordinate system in a manner such that the three-dimensional point cloud data is measured from the mobile body having the corrected absolute position and the corrected absolute posture in the absolute coordinate system. Next, the map data generation unit 130 generates new map point cloud data by integrating a series of three-dimensional point cloud data at each time generated in the absolute coordinate system and the map point cloud data. Then, the map data generation unit 130 updates the map point cloud data by storing the new map point cloud data in the map point cloud data storage unit 110.

Next, operation of the position and posture estimation device 10 will be described.

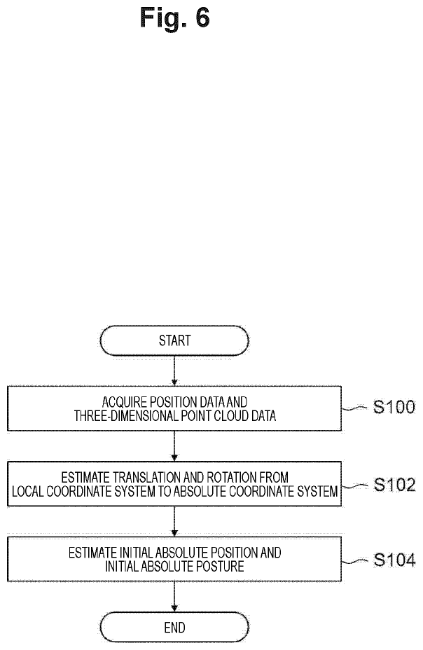

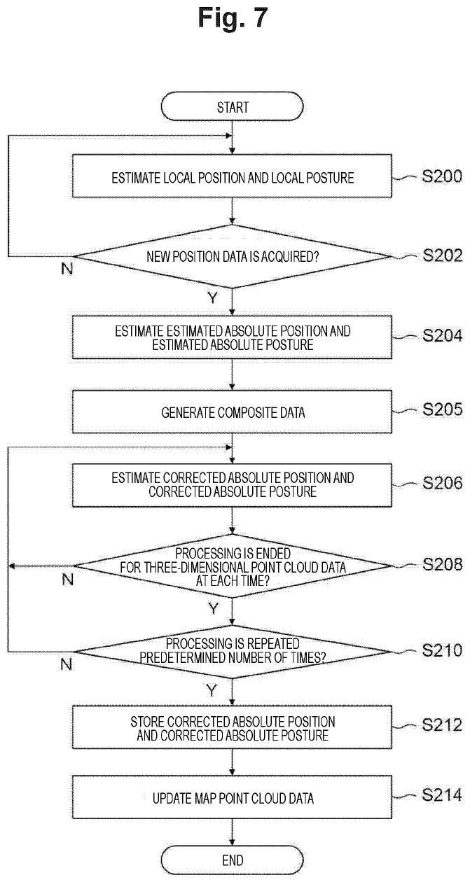

FIGS. 6 and 7 are flowcharts of a flow of processing by the position and posture estimation device 10. The CPU 11 reads a program from the ROM 12 or the storage 14, and develops the program in the RAM 13 and executes the program, whereby the processing is performed.

When the position data is stored in the position data storage unit 100 and the three-dimensional point cloud data is stored in the three-dimensional point cloud data storage unit 102, the position and posture estimation device 10 executes the flowchart illustrated in FIG. 6.

In step S100, when new position data is stored in the position data storage unit 100, the CPU 11, as the acquisition unit 120, acquires the three-dimensional point cloud data measured at each time from storage of the position data of the previous time to storage of the position data of the current time, the position data of the current time, and the position data of the previous time. Note that, the acquisition unit 120 acquires the three-dimensional point cloud data from the three-dimensional point cloud data storage unit 102, and acquires the position data from the position data storage unit 100.

In step S102, the CPU 11, as the initial estimation unit 122, estimates the translation from the local position of the mobile body in the local coordinate system to the estimated absolute position of the mobile body in the absolute coordinate system, and estimates the rotation from the local posture of the mobile body in the local coordinate system to the estimated absolute posture of the mobile body in the absolute coordinate system.

In step S104, the CPU 11, as the initial estimation unit 122, estimates an initial estimated absolute position of the mobile body and an initial estimated absolute posture of the mobile body on the basis of the translation and the rotation estimated in step S100.

The initial absolute position and the initial absolute posture are estimated from the flowchart of FIG. 6. The initial estimated absolute position and the initial estimated absolute posture are used in the flowchart of FIG. 7 described later. Every time the three-dimensional point cloud data is stored in the three-dimensional point cloud data storage unit 102, the position and posture estimation device 10 executes the flowchart illustrated in FIG. 7. At this time, the acquisition unit 120 acquires the position data and the three-dimensional point cloud data.

In step S200, every time three-dimensional point cloud data is acquired with the lapse of the first time and the three-dimensional point cloud data is stored in the three-dimensional point cloud data storage unit 102, the CPU 11, as the first estimation unit 124, estimates the local position representing the position of the mobile body in the local coordinate system and the local posture representing the posture of the mobile body in the local coordinate system on the basis of the three-dimensional point cloud data acquired by the acquisition unit 120 by using the known method such as Non Patent Literature 1 or Non Patent Literature 2. Then, the first estimation unit 124 stores the local position and the local posture in the local coordinate data storage unit 104.

In step S202, the CPU 11, as the second estimation unit 126, determines whether or not new position data is stored in the position data storage unit 100. When new position data is stored in the position data storage unit 100, the processing proceeds to step S204. When no new position data is stored in the position data storage unit 100, the processing returns to step S200.

In step S204, the CPU 11, as the second estimation unit 126, estimates the estimated absolute position that is the position of the mobile body in the absolute coordinate system on the basis of the local position of the mobile body estimated in step S200. In addition, the CPU 11, as the second estimation unit 126, estimates the estimated absolute posture that is the posture of the mobile body in the absolute coordinate system on the basis of the local posture of the mobile body estimated in step S200. Then, the second estimation unit 126 stores the estimated absolute position and the estimated absolute posture in the absolute coordinate data storage unit 106.

In step S205, the CPU 11, as the correction unit 128, generates the provisional three-dimensional point cloud data in the absolute coordinate system by applying the translation and the rotation estimated by the initial estimation unit 122 to the three-dimensional point cloud data at each time measured every time the first time elapses. Then, the correction unit 128 generates the composite data that is the three-dimensional point cloud data obtained by combining the provisional three-dimensional point cloud data with the map point cloud data generated up to the previous time stored in the map point cloud data storage unit 110.

In step S206, the CPU 11, as the correction unit 128, corrects the estimated absolute position and the estimated absolute posture to increase the degree of coincidence between the composite data generated in step S205 and the map point cloud data, for each piece of three-dimensional point cloud data at each time, thereby generating the corrected absolute position obtained by correcting the estimated absolute position and the corrected absolute posture obtained by correcting the estimated absolute posture.

In step S208, the CPU 11, as the correction unit 128, determines whether or not the processing in step S206 is ended for the three-dimensional point cloud data at each time. In a case where the processing of step S206 is ended for the three-dimensional point cloud data at each time, the processing proceeds to step S210. On the other hand, in a case where there is three-dimensional point cloud data for which the processing in step S206 is not ended, the processing returns to step S206.

In step S210, the CPU 11, as the correction unit 128, determines whether or not the processing of step S206 is repeated a predetermined number of times. In a case where the processing of step S206 is repeated the predetermined number of times, the processing proceeds to step S212. On the other hand, in a case where the processing of step S206 is not repeated the predetermined number of times, the processing returns to step S206. The processing of step S206 is repeated the predetermined number of times, whereby the corrected absolute position and the corrected absolute posture are accurately estimated.

In step S212, the CPU 11, as the correction unit 128, stores the corrected absolute position and the corrected absolute posture obtained in step S206 in the corrected data storage unit 108.

In step S214, the CPU 11, as the map data generation unit 130, generates the series of three-dimensional point cloud data in the second time section of the current time by applying the translation and the rotation estimated by the initial estimation unit 122 to each piece of three-dimensional point cloud data at each time. Next, the map data generation unit 130 generates each piece of three-dimensional point cloud data at each time in the absolute coordinate system in a manner such that the three-dimensional point cloud data is measured from the mobile body having the corrected absolute position and the corrected absolute posture in the absolute coordinate system. Next, the map data generation unit 130 generates new map point cloud data by integrating a series of three-dimensional point cloud data at each time generated in the absolute coordinate system and the map point cloud data. Then, the map data generation unit 130 updates the map point cloud data by storing the new map point cloud data in the map point cloud data storage unit 110.

As described above, the position and posture estimation device according to the embodiment acquires the three-dimensional point cloud data at each time measured every time the first time elapses by the measuring instrument mounted on the mobile body and the position data at each time measured every time the second time longer than the first time elapses by the position measuring device mounted on the mobile body. Every time the three-dimensional point cloud data is acquired with the lapse of the first time, the position and posture estimation device estimates the local position representing the position of the mobile body in the local coordinate system with the position at the start of movement of the mobile body as the origin and the local posture representing the posture of the mobile body in the local coordinate system on the basis of the three-dimensional point cloud data acquired. Every time the position data is acquired with the lapse of the second time, the position and posture estimation device estimates the estimated absolute position that is the position of the mobile body in the absolute coordinate system with the predetermined position on Earth as the origin on the basis of the local position of the mobile body, and estimates the estimated absolute posture that is the posture of the mobile body in the absolute coordinate system on the basis of the local posture of the mobile body. Every time the position data is acquired with the lapse of the second time, the position and posture estimation device generates the provisional three-dimensional point cloud data at each time in the absolute coordinate system, for each piece of three-dimensional point cloud data at each time measured every time the first time elapses, and generates the composite data obtained by integrating the provisional three-dimensional point cloud data and the map point cloud data generated from the three-dimensional point cloud data previously measured, for each piece of the provisional three-dimensional point cloud data at each time. Then, the position and posture estimation device generates the corrected absolute position obtained by correcting the estimated absolute position and the corrected absolute posture obtained by correcting the estimated absolute posture, by correcting the estimated absolute position and the estimated absolute posture to increase the degree of coincidence between the composite data and the map point cloud data. As a result, the position and the posture of the mobile body in the absolute coordinate system can be accurately estimated on the basis of the position data obtained by the position measuring device mounted on the mobile body and the three-dimensional point cloud data obtained by the measuring instrument mounted on the mobile body.

In addition, the estimated absolute position and the estimated absolute posture are corrected every time the position data is acquired, whereby the drift occurring in the LiDAR is reduced, and the position and the posture of the mobile body in the absolute coordinate system are accurately estimated.

In addition, according to the present embodiment, a problem is also solved that the absolute position and the absolute posture of the mobile body cannot be obtained by not using the GPS. In addition, according to the present embodiment, a problem is also solved that calibration between the LiDAR and the IMU is required in a case where the IMU is mounted on the mobile body. Therefore, according to the present embodiment, calibration between the IMU and the LiDAR is unnecessary, and the absolute position and the absolute posture of the mobile body can be estimated only by the GPS and the LiDAR.

In addition, according to the present embodiment, it is possible to generate new map point cloud data by generating each piece of three-dimensional point cloud data at each time in the absolute coordinate system in a manner such that the three-dimensional point cloud data is measured from the mobile body having the corrected absolute position and the corrected absolute posture, and integrating the series of three-dimensional point cloud data at each time generated in the absolute coordinate system and the map point cloud data.

Note that, the various types of processing executed by the CPU reading software (program) in the above embodiment may be executed by various processors other than the CPU. Examples of the processors in this case include a programmable logic device (PLD) of which a circuit configuration can be changed after manufacturing, such as a field-programmable gate array (FPGA), and a dedicated electric circuit that is a processor having a circuit configuration exclusively designed for executing a specific processing, such as an application specific integrated circuit (ASIC). In addition, the various types of processing may be executed by one of the various processors or may be executed by a combination of two or more processors of the same type or different types (for example, a combination of a plurality of FPGAs or a combination of a CPU and an FPGA). In addition, more specifically, a hardware structure of the various processors is an electric circuit in which circuit elements such as semiconductor elements are combined.

In addition, in each embodiment described above, the aspect has been described in which the program is stored (installed) in advance in the storage 14, but the present invention is not limited thereto. The program may be provided in a form of a program stored in a non-transitory storage medium such as a compact disk read only memory (CD-ROM), a digital versatile disk read only memory (DVD-ROM), or a universal serial bus (USB) memory. In addition, the program may be downloaded from an external device via a network.

Regarding the above embodiment, the following supplementary notes are further disclosed.

### (Supplement 1)

A position and posture estimation device including:
a memory; and
at least one processor connected to the memory, in which
the processor is configured to:
acquire three-dimensional point cloud data at each of times and position data at each of times, the three-dimensional point cloud data being measured every time a first time elapses by a measuring instrument mounted on a mobile body, the position data being measured every time a second time longer than the first time elapses by a position measuring device mounted on the mobile body;
estimate a local position representing a position of the mobile body in a local coordinate system with a position at a start of movement of the mobile body as the origin and a local posture representing a posture of the mobile body in the local coordinate system, on the basis of the three-dimensional point cloud data acquired, every time the three-dimensional point cloud data is acquired with a lapse of the first time;
estimate an estimated absolute position that is a position of the mobile body in an absolute coordinate system with a predetermined position on Earth as the origin on the basis of the local position of the mobile body, and estimates an estimated absolute posture that is a posture of the mobile body in the absolute coordinate system on the basis of the local posture of the mobile body, every time the position data is acquired with a lapse of the second time; and
generate provisional three-dimensional point cloud data at each of times in the absolute coordinate system for each of pieces of the three-dimensional point cloud data at each of times, the three-dimensional point cloud data being measured every time the first time elapses, generate composite data obtained by integrating the provisional three-dimensional point cloud data and map point cloud data generated from three-dimensional point cloud data previously measured, for each of pieces of the provisional three-dimensional point cloud data at each of times, and generate a corrected absolute position obtained by correcting the estimated absolute position and a corrected absolute posture obtained by correcting the estimated absolute posture, by correcting the estimated absolute position and the estimated absolute posture to increase a degree of coincidence between the composite data and the map point cloud data, every time the position data is acquired with the lapse of the second time.

### (Supplement 2)

A non-transitory storage medium storing a program executable by a computer to execute position and posture estimation processing,
the position and posture estimation processing including:
acquiring three-dimensional point cloud data at each of times and position data at each of times, the three-dimensional point cloud data being measured every time a first time elapses by a measuring instrument mounted on a mobile body, the position data being measured every time a second time longer than the first time elapses by a position measuring device mounted on the mobile body;
estimating a local position representing a position of the mobile body in a local coordinate system with a position at a start of movement of the mobile body as the origin and a local posture representing a posture of the mobile body in the local coordinate system, on the basis of the three-dimensional point cloud data acquired, every time the three-dimensional point cloud data is acquired with a lapse of the first time;
estimating an estimated absolute position that is a position of the mobile body in an absolute coordinate system with a predetermined position on Earth as the origin on the basis of the local position of the mobile body, and estimating an estimated absolute posture that is a posture of the mobile body in the absolute coordinate system on the basis of the local posture of the mobile body, every time the position data is acquired with a lapse of the second time; and
generating provisional three-dimensional point cloud data at each of times in the absolute coordinate system for each of pieces of the three-dimensional point cloud data at each of times, the three-dimensional point cloud data being measured every time the first time elapses, generating composite data obtained by integrating the provisional three-dimensional point cloud data and map point cloud data generated from three-dimensional point cloud data previously measured, for each of pieces of the provisional three-dimensional point cloud data at each of times, and generating a corrected absolute position obtained by correcting the estimated absolute position and a corrected absolute posture obtained by correcting the estimated absolute posture, by correcting the estimated absolute position and the estimated absolute posture to increase a degree of coincidence between the composite data and the map point cloud data, every time the position data is acquired with the lapse of the second time.

### REFERENCE SIGNS LIST

100 Position data storage unit
102 Three-dimensional point cloud data storage unit
104 Local coordinate data storage unit
106 Absolute coordinate data storage unit
108 Corrected data storage unit
110 Map point cloud data storage unit
120 Acquisition unit
122 Initial estimation unit
124 First estimation unit
126 Second estimation unit
128 Correction unit
130 Map data generation unit

1. A position and posture estimation method in which a computer executes processing including:
acquiring three-dimensional point cloud data at each of times and position data at each of times, the three-dimensional point cloud data being measured every time a first time elapses by a measuring instrument mounted on a mobile body, the position data being measured every time a second time longer than the first time elapses by a position measuring device mounted on the mobile body;
estimating a local position representing a position of the mobile body in a local coordinate system with a position at a start of movement of the mobile body as an origin and a local posture representing a posture of the mobile body in the local coordinate system, on a basis of the three-dimensional point cloud data acquired, every time the three-dimensional point cloud data is acquired with a lapse of the first time;
estimating an estimated absolute position that is a position of the mobile body in an absolute coordinate system with a predetermined position on Earth as an origin on a basis of the local position of the mobile body, and estimating an estimated absolute posture that is a posture of the mobile body in the absolute coordinate system on a basis of the local posture of the mobile body, every time the position data is acquired with a lapse of the second time; and
generating provisional three-dimensional point cloud data at each of times in the absolute coordinate system for each of pieces of the three-dimensional point cloud data at each of times, the three-dimensional point cloud data being measured every time the first time elapses, generating composite data obtained by integrating the provisional three-dimensional point cloud data and map point cloud data generated from three-dimensional point cloud data previously measured, for each of pieces of the provisional three-dimensional point cloud data at each of times, and generating a corrected absolute position obtained by correcting the estimated absolute position and a corrected absolute posture obtained by correcting the estimated absolute posture, by correcting the estimated absolute position and the estimated absolute posture to increase a degree of coincidence between the composite data and the map point cloud data, every time the position data is acquired with the lapse of the second time.

2. The position and posture estimation method according to claim 1, wherein
each of pieces of the three-dimensional point cloud data at each of times in the absolute coordinate system is generated in a manner such that the three-dimensional point cloud data is measured from the mobile body having the corrected absolute position and the corrected absolute posture, and a series of the three-dimensional point cloud data at each of times generated in the absolute coordinate system and the map point cloud data are integrated to generate new map point cloud data.

3. The position and posture estimation method according to claim 1, wherein
when the estimated absolute position and the estimated absolute posture are estimated, every time the position data is acquired with the lapse of the second time, the local position of the mobile body estimated is set as an estimated absolute position that is a position in the absolute coordinate system, and rotation representing a difference between the local posture of the mobile body estimated at a current time and the local posture of the mobile body estimated at a previous time is applied to a corrected absolute posture of the mobile body obtained on a basis of the position data of the previous time, to estimate an estimated absolute posture that is a posture in the absolute coordinate system of the current time.

4. The position and posture estimation method according to claim 1, wherein
when the estimated absolute position and the estimated absolute posture are estimated, a degree of coincidence between the provisional three-dimensional point cloud data and the three-dimensional point cloud data is calculated by using an iterative closest point (ICP) algorithm, and the estimated absolute position and the estimated absolute posture are corrected to increase the degree of coincidence.

5. A position and posture estimation device comprising:
an acquisition unit that acquires three-dimensional point cloud data at each of times and position data at each of times, the three-dimensional point cloud data being measured every time a first time elapses by a measuring instrument mounted on a mobile body, the position data being measured every time a second time longer than the first time elapses by a position measuring device mounted on the mobile body;
a first estimation unit that estimates a local position representing a position of the mobile body in a local coordinate system with a position at a start of movement of the mobile body as an origin and a local posture representing a posture of the mobile body in the local coordinate system, on a basis of the three-dimensional point cloud data acquired, every time the three-dimensional point cloud data is acquired with a lapse of the first time;
a second estimation unit that estimates an estimated absolute position that is a position of the mobile body in an absolute coordinate system with a predetermined position on Earth as an origin on a basis of the local position of the mobile body, and estimates an estimated absolute posture that is a posture of the mobile body in the absolute coordinate system on a basis of the local posture of the mobile body, every time the position data is acquired with a lapse of the second time; and
a correction unit that generates provisional three-dimensional point cloud data at each of times in the absolute coordinate system for each of pieces of the three-dimensional point cloud data at each of times, the three-dimensional point cloud data being measured every time the first time elapses, generates composite data obtained by integrating the provisional three-dimensional point cloud data and map point cloud data generated from three-dimensional point cloud data previously measured, for each of pieces of the provisional three-dimensional point cloud data at each of times, and generates a corrected absolute position obtained by correcting the estimated absolute position and a corrected absolute posture obtained by correcting the estimated absolute posture, by correcting the estimated absolute position and the estimated absolute posture to increase a degree of coincidence between the composite data and the map point cloud data, every time the position data is acquired with the lapse of the second time.

6. A program for causing a computer to execute processing including:
acquiring three-dimensional point cloud data at each of times and position data at each of times, the three-dimensional point cloud data being measured every time a first time elapses by a measuring instrument mounted on a mobile body, the position data being measured every time a second time longer than the first time elapses by a position measuring device mounted on the mobile body;
estimating a local position representing a position of the mobile body in a local coordinate system with a position at a start of movement of the mobile body as an origin and a local posture representing a posture of the mobile body in the local coordinate system, on a basis of the three-dimensional point cloud data acquired, every time the three-dimensional point cloud data is acquired with a lapse of the first time;
estimating an estimated absolute position that is a position of the mobile body in an absolute coordinate system with a predetermined position on Earth as an origin on a basis of the local position of the mobile body, and estimating an estimated absolute posture that is a posture of the mobile body in the absolute coordinate system on a basis of the local posture of the mobile body, every time the position data is acquired with a lapse of the second time; and
generating provisional three-dimensional point cloud data at each of times in the absolute coordinate system for each of pieces of the three-dimensional point cloud data at each of times, the three-dimensional point cloud data being measured every time the first time elapses, generating composite data obtained by integrating the provisional three-dimensional point cloud data and map point cloud data generated from three-dimensional point cloud data previously measured, for each of pieces of the provisional three-dimensional point cloud data at each of times, and generating a corrected absolute position obtained by correcting the estimated absolute position and a corrected absolute posture obtained by correcting the estimated absolute posture, by correcting the estimated absolute position and the estimated absolute posture to increase a degree of coincidence between the composite data and the map point cloud data, every time the position data is acquired with the lapse of the second time.

7. The position and posture estimation device according to claim 5, wherein
each of pieces of the three-dimensional point cloud data at each of times in the absolute coordinate system is generated in a manner such that the three-dimensional point cloud data is measured from the mobile body having the corrected absolute position and the corrected absolute posture, and a series of the three-dimensional point cloud data at each of times generated in the absolute coordinate system and the map point cloud data are integrated to generate new map point cloud data.

8. The position and posture estimation device according to claim 5, wherein
when the estimated absolute position and the estimated absolute posture are estimated, every time the position data is acquired with the lapse of the second time, the local position of the mobile body estimated is set as an estimated absolute position that is a position in the absolute coordinate system, and rotation representing a difference between the local posture of the mobile body estimated at a current time and the local posture of the mobile body estimated at a previous time is applied to a corrected absolute posture of the mobile body obtained on a basis of the position data of the previous time, to estimate an estimated absolute posture that is a posture in the absolute coordinate system of the current time.

9. The position and posture estimation device according to claim 5, wherein
when the estimated absolute position and the estimated absolute posture are estimated, a degree of coincidence between the provisional three-dimensional point cloud data and the three-dimensional point cloud data is calculated by using an iterative closest point (ICP) algorithm, and the estimated absolute position and the estimated absolute posture are corrected to increase the degree of coincidence.

10. The program according to claim 6, wherein
each of pieces of the three-dimensional point cloud data at each of times in the absolute coordinate system is generated in a manner such that the three-dimensional point cloud data is measured from the mobile body having the corrected absolute position and the corrected absolute posture, and a series of the three-dimensional point cloud data at each of times generated in the absolute coordinate system and the map point cloud data are integrated to generate new map point cloud data.

11. The program according to claim 6, wherein
when the estimated absolute position and the estimated absolute posture are estimated, every time the position data is acquired with the lapse of the second time, the local position of the mobile body estimated is set as an estimated absolute position that is a position in the absolute coordinate system, and rotation representing a difference between the local posture of the mobile body estimated at a current time and the local posture of the mobile body estimated at a previous time is applied to a corrected absolute posture of the mobile body obtained on a basis of the position data of the previous time, to estimate an estimated absolute posture that is a posture in the absolute coordinate system of the current time.

12. The program according to claim 6, wherein
when the estimated absolute position and the estimated absolute posture are estimated, a degree of coincidence between the provisional three-dimensional point cloud data and the three-dimensional point cloud data is calculated by using an iterative closest point (ICP) algorithm, and the estimated absolute position and the estimated absolute posture are corrected to increase the degree of coincidence.

13. The position and posture estimation method according to claim 1, wherein a temporary three-dimensional point cloud data is synthesized at each time and the map point cloud data generated up to the last time every time the position data is acquired after the second time has passed.

14. The position and posture estimation method according to claim 4, wherein the ICP algorithm is used to generate a corrected absolute position and a corrected absolute attitude of a moving object when three-dimensional point cloud data is measured.

15. The position and posture estimation method according to claim 14, wherein the estimated absolute position and the estimated absolute orientation at a time are used to generate the corrected absolute position and the corrected absolute attitude by correcting the estimated absolute position and the estimated absolute attitude.

16. The position and posture estimation method according to claim 1, wherein the three-dimensional point cloud data is converted at times and rotation from the local pose to the estimated absolute pose are applied to generate the temporary three-dimensional point cloud data for each instant.

17. The position and posture estimation device according to claim 5, wherein the correction unit synthesizes a temporary three-dimensional point cloud data at each time and the map point cloud data generated up to the last time every time the position data is acquired after the second time has passed.

18. The position and posture estimation device according to claim 5, wherein the ICP algorithm is used to generate a corrected absolute position and a corrected absolute attitude of a moving object when three-dimensional point cloud data is measured.

19. The position and posture estimation device according to claim 18, wherein the correction unit uses the estimated absolute position and the estimated absolute orientation at a time to generate the corrected absolute position and the corrected absolute attitude by correcting the estimated absolute position and the estimated absolute attitude.

20. The position and posture estimation device according to claim 5, wherein the correction unit converts the three-dimensional point cloud data at times and rotation from the local pose to the estimated absolute pose is applied to generate the temporary three-dimensional point cloud data for each instant.
